(19) United States
(12) Patent Application Publication
(10) Pub. No.: US 2014/0351245 A1
(43) Pub. Date: Nov. 27, 2014

(54) SEARCH ENGINE SYSTEM AND METHOD EMPLOYING WAVE EQUATIONS FOR CLASSIFYING AND RANKING SEARCH RESULTS

(71) Applicant: Paige Johnson, Collinsville, OK (US)

(72) Inventor: Paige Johnson, Collinsville, OK (US)

(21) Appl. No.: 14/209,030

(22) Filed: Mar. 13, 2014

Related U.S. Application Data
(60) Provisional application No. 61/779,614, filed on Mar. 13, 2013.

(51) Int. Cl. G06F 17/30

(52) U.S. Cl. CPC G06F 17/30867
USPC 707/723

(57) ABSTRACT

An internet search system and method made according to this invention provides a rating/ranking for internet search results that emphasizes the discovery and curation of new content by publishers. Time-stamped internet search data is sorted and classified by detecting peaks and troughs in that data and describing them with one or more wave equations. The data is then classified into ripples according to the peak or trough in which it appears. Each search result may also be scored as a function of the detected peak in which it appears and the number of other search results within the same peak. The search system and method make these classifications and scores visible to the user by displaying them in textual, visual, or textual and visual form.

### CROSS REFERENCE TO PENDING APPLICATIONS

This application claims priority to U.S. Provisional Patent Application Ser. No. 61/779,614, filed Mar. 13, 2013.

### BACKGROUND OF THE INVENTION

This invention relates generally to computing systems and methods for providing relevant internet search results to a user. More specifically, this invention relates to systems and methods which make use of wave equations to provide a rating/ranking that emphasizes the discovery and curation of new content.

Fundamentally, search engines allow a user to enter a query and receive one or more internet results in response. These results (also referred to herein as data) are sometimes created within the search engine itself, but are more generally links to other content creators using Uniform Resource Locators (URLs) and corresponding descriptive information. Because of the quantity of results available, various search algorithms are used to sort the results and display them to the user. Some of those algorithms are link-based, ranking and organizing search results based upon the popularity of established content as demonstrated by links from other content creators.

Link-based algorithms emphasize popularity, not originality. In a set of results sorted and ranked by a link-based algorithm, users find it difficult to discover content that is truly new. It is possible, and even common, for a less popular creator to have their content co-opted by a more popular creator. Since content published by a more popular creator ranks higher in a link-based algorithm, it becomes difficult for a user to find, recognize, and properly credit a less popular creator who originated the information. Over time, a link-based algorithm can result in a hegemony of popular sites, making it more difficult for new content creators to participate.

Other algorithms are time-based. However, those presently disclosed are not used to rank or display content based on its originality. The algorithm disclosed in U.S. Pat. No. 8,326,836 makes use of “time series” information and can extract times from resources that are associated with a date. The sources of information are not ranked, and the decision to display the search results is based on some form of cost-benefit analysis rather than time.

The algorithm disclosed in U.S. Pat. No. 8,335,785 scores weblogs based on the time when information pertaining to the search query appeared on weblogs and displays their ranking. The rankings rely upon influence weighing and link inference, and the algorithm does not attempt to classify the search results into categories.

The algorithms disclosed in U.S. Pat. Nos. 7,792,827, 8,082,244, and 8,234,273 also use time, or time in combination with other factors, to rank sources of information. None of these teach or suggest an algorithm or classification system the same or similar to the inventive system disclosed herein.

It is desirable, therefore, that there be a technical innovation that makes the originality of content easily visible to the user and that emphasizes the discovery and curation of new content by publishers. The innovation disclosed herein uses time-stamps on internet results to classify, rank, and display those results based upon their appearance relative to other results by executing an algorithm that utilizes one or more logic tests and wave equations to provide ranking and scoring of the results. Publishers are incentivized to produce original content in order to appear higher in the display of results. Users are provided with a simple way to evaluate originality of content. An unexpected technical benefit is the provision of a new way to evaluate relationships between publishers and to study how information is disseminated online.

### SUMMARY OF THE INVENTION

An internet search system and method made according to this invention sorts and classifies time-stamped internet search data by detecting and describing peaks and troughs in that data. These peaks and troughs can be thought of as compressions and rarefactions in the data. A peak or compression would correspond to a point or range of time in which there were more appearances of a searched term relative to points or ranges of time before and after the compression. A trough or rarefaction would correspond to a point or range of time in which there were fewer appearances of a search term relative to points or ranges of time before and after the trough or rarefaction.

The peaks and troughs are detected and described using logical statements and mathematical models. Appropriate logical statements include those which ascertain whether the number of appearances in a time period are greater or less than the number of appearances in a prior time period. Appropriate mathematical models include equations which can be used to describe waves or to fit data into waves. A single equation or a combination of multiple equations may be used for the detection and description of the peaks and troughs.

Detecting and describing the peaks and troughs allows the time-stamped internet search data to be classified according to the peak or trough in which it appears (e.g., the first, second, third, or nth peak from a point of origin). This classification scheme is analogous to what is commonly referred to as a ripple, namely, a series of waves extending from a common center. The ripple may be a combination of a peak and a trough or any of a peak or a trough whether taken singly or in combination.

The search system and method makes these classifications visible to the user by displaying them in textual, visual, or textual and visual form. For example, search data appearing in the first peak may be called “discoverers.” As another example, the search data in the first peak may be displayed in a visual image of a ripple as being a part of the wave closest to the center of the ripple. Some data may further be classified and displayed as the source of the ripple, a single appearance or a cluster of appearances of the search term from which the other waves emanate.

The ripple classifications are used to rank and display data. For example, those search data appearing in the first peak would have a higher ranking than those appearing in the second peak and, because of that ranking, would appear at the top of the data list. This is analogous to a physical ripple in which the first wave has the highest amplitude. The ranking may further be refined by incorporating the total number of appearances in that ripple as a measure of how unique the appearance is. For example, data in a peak with only 10 total appearances of the search term would have a higher ranking than data in a peak with 1000 total appearances of the search term. It is possible for highly unique data to outrank earlier data that is less unique, demonstrating that the invention is not simply ranking data in time order. Ranking and displaying the data in this way is a technical innovation that emphasizes the originality of content, and allows the user to quickly and easily perceive the originality of content.

The ripple classifications can also be applied to time-stamped internet search data that is grouped by some other parameter, for example by website or by author. The grouped data can be given an additional ranking or score based on a statistical measure of its overall ripple classifications. For example, the additional ranking can be based on the number or characteristics of the wave in which its time-stamped data most often appears, indicating whether the website or publisher is most often a “discoverer” or a “repeater” or “noise.” In another example, the additional ranking could be based on whether the grouped data appears most often early in a given peak or late in a given peak, indicating whether the website or publisher is a “leader” or a “lagger.” Classifying the data in this way is a technical innovation that makes it apparent whether a website or author is providing original content.

The grouping could also be a limitation of time. For example, the algorithm could be applied to only the last six months of data or to only the first hours after a news event was reported. Another time-grouping could be that selected from the algorithm itself, for example only dates falling within the “discoverer” category could be selected for further application of the algorithm. The grouping could be according to the type or source of data. For example, the algorithm could be applied to video content only, or to twitter results only. The grouping could be relative to another website or author or group of websites or authors. For example, online items by a newspaper columnist could be compared to those by a blogger. Classifying the data in this way is a technical innovation that provides a new tool to users with which to examine relationships between publishers, and how original content is disseminated over time.

### BRIEF DESCRIPTION OF THE DRAWINGS

FIG. 1 illustrates an exemplary computing architecture according to an embodiment of the present invention.

FIG. 2. illustrates an exemplary flow diagram according to an embodiment of the present invention.

FIG. 3 is a table showing a simplified example search result and its classification into ripples using a preferred embodiment of an internet search system and method made according to this invention. The example shows one way in which the search results relative to time may be described by wave equations.

FIG. 4 is an image showing one way in which the system and method of this invention may be displayed to a user.

### DETAILED DESCRIPTION OF THE PREFERRED EMBODIMENTS

The present invention is directed to classifying and ranking the results of searches of network-accessible documents. It is readily understood by those of ordinary skill in the art that a user may perform a query of such documents and receive in response to the performing a list of results, or data. As noted earlier, it is desirable to be able to easily evaluate the originality of this data. An internet search system and method made according to this invention makes use of computer means executing an algorithm that utilizes one or more logic tests and wave equations to provide a rating/ranking that emphasizes the discovery and curation of new content, rather than the popularity of established content as emphasized by link-based algorithms.

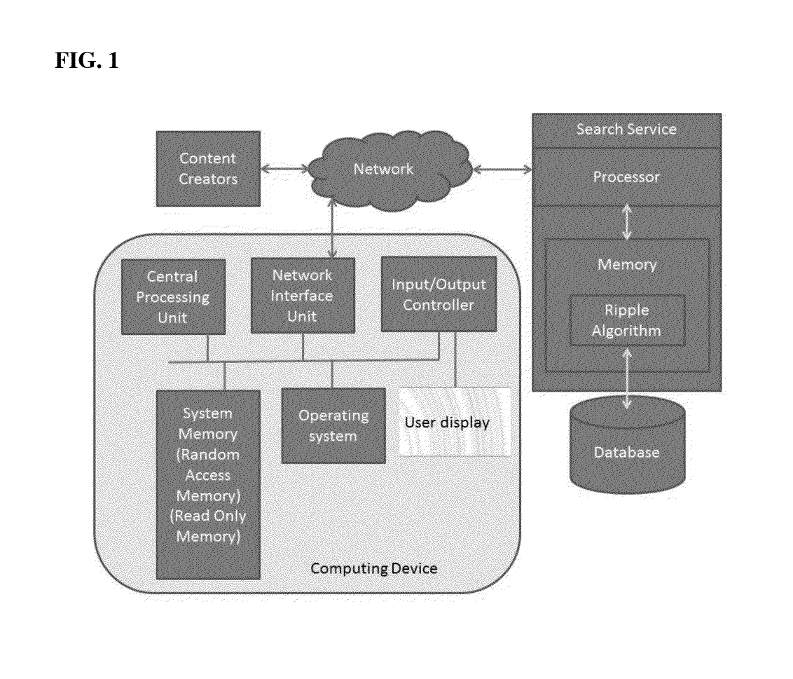

The system accomplishes its intended purpose by a method for searching, classifying, and sorting electronic data based upon time of appearance relative to other similar pieces of data in a data set. FIG. 1 shows an exemplary computer architecture that can be utilized in the embodiments. The computer architecture may be configured as a desktop computing device, a mobile computing device, or a server computing device or some other system that includes a central processing unit (“CPU”) and memory. As shown in FIG. 1, a computing device such as a personal computer, mobile computing device, or server computing device can interact with a network to request content by way of a search query submitted to a search service. The network is not limited to any particular type of network. The content provided to the network comes from content creators or publishers who have made their content network-accessible. Numerous publishers and computing devices may participate in the network. It is obvious to those skilled in the art that the computing device and the network may communicate with each other using a variety of configurations of equipment and protocols.

One skilled in the art will also appreciate that when a user enters a query into a computing device, it can be passed to the network and thus to a search service, as shown in FIG. 1. Upon receiving the query, the search service may interact with a database to retrieve results related to the query. It may do so independently, or in conjunction with other search engines in use now or developed in the future. The search service initiates the use of the ripple algorithm to describe and rank the results retrieved from the database. Results are passed to the network and on to the computer device, where they are displayed to the user.

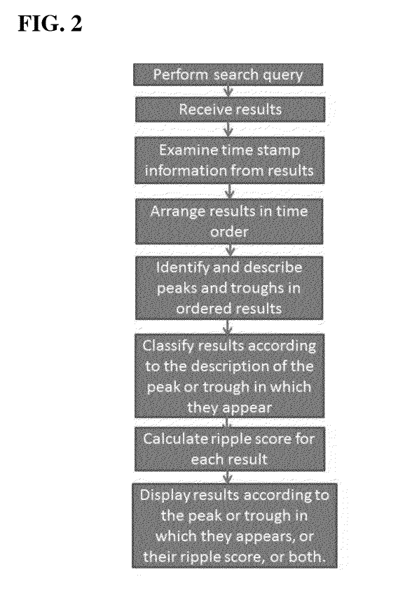

FIG. 2 illustrates an exemplary flow diagram in accordance with the invention. The system and method include the following steps:
1. Perform a search query;
2. Receive results;
3. Examine time stamp information associated with the results;
4. Arrange the results in time order (e.g., oldest date to newest date);
5. Identify and describe any number of ripples (i.e., peaks and troughs in the ordered results);
6. Classify the results according to the ripple in which an individual result appears;
7. Calculate a score based upon the ripple in which each result appears and the number of other results in that ripple; and
8. Display the results according to their assigned score, classification, or ripple number.

Which ripple the data falls in determines the classification of that entry. For example,
Ripple 1: Discoverer
Ripple 2: Curator
Ripple 3: Responder
Ripple 4: Repeater
Ripple 5: Echo
Ripple 6: Noise
   More than six ripples are possible, or later data may simply be discarded or given a score of zero since the object is to emphasize discovery and curation.

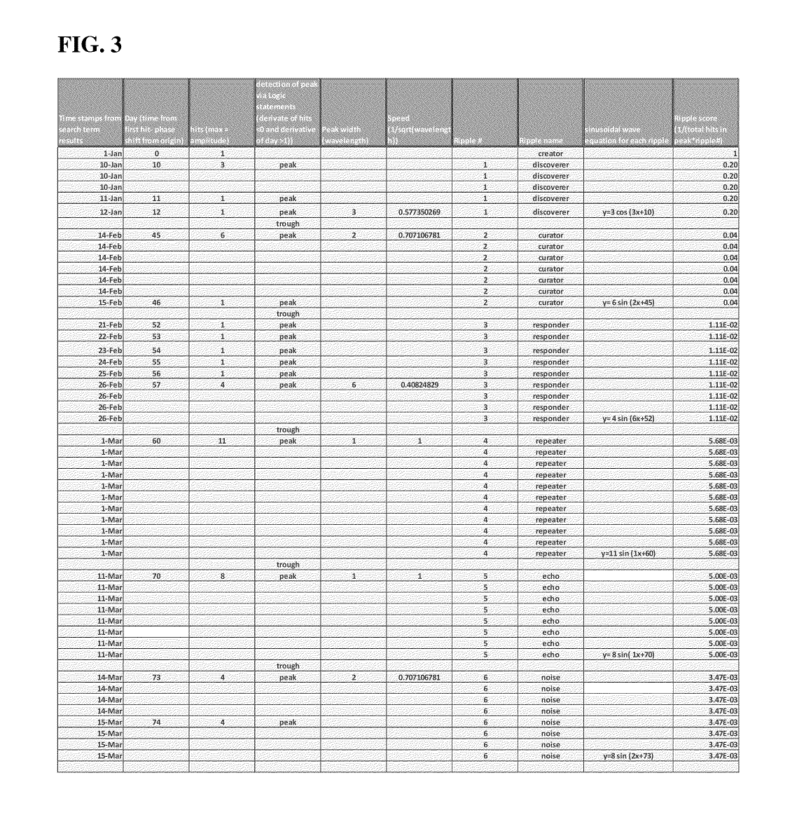

For example, and referring to FIG. 3, on January 1, there was one “hit,” or result. In cases such as this example in which a first hit can be clearly identified, it can be classified as the origin of the ripple, and a “creator.” The date on which the first hit occurs counts as Day 0, irrespective of its calendar date. On January 10, there were 3 hits. On January 11 there was one hit, and on January 12 there was one hit, and then there were no hits until February 14. By looking at a combination of the derivative of the hits (i.e., are they increasing or decreasing) and of the days (is there a lapse in hits greater than the time period being examined, in this case days) the hits on January 10, 11, and 12 are identified as being in the first peak. Since they are in the first ripple, they are classified as “discoverers” (see FIG. 3, col. 8). Both the time period and the logical conditions can be adjusted to best separate peaks and troughs in the data.

The peak may be described as a wave with the “amplitude” of the peak being equal to the maximum number of hits anywhere in the peak, in this case three. The “wavelength” of the peak is equal to the time span it covers, in this case three days. The “phase” of the peak is equal to its distance from the origin (here defined as Day 0), in this case 10. This leads to the general sinusoidal equation for the peak of y=3 cos(3x+10) (see FIG. 3, col. 9). Further parameters, such as the “speed” of the peak (1/sqrt(wavelength)) can be defined. The type of wave equation used can be adjusted in order to best represent the data. The wave equations for individual peaks can be combined and/or transformed to represent the data set as a whole.

Individual hits can be given a numeric score (see FIG. 3, col. 10) that can be integrated into other search engine rankings, for example link-based rankings. In order to emphasize original discovery and curation, it is advantageous to make that score inversely proportional to the number of hits in the ripple (i.e., fewer entries=more originality=higher score) and to the number of the ripple (i.e., lower ripple number=earlier discovery=higher score). To ensure that the ripple number is the most heavily weighted component, its square is used. Other weighting schemes could also be used.

In this example, there are five total hits in the first ripple. Each hit in the first ripple receives a score of 1/(hits*ripple number̂2), which in this case is 3/(5*1̂2), or 0.20. The amplitude of the sixth ripple is 4, and there are eight total hits in it. Each hit in the sixth ripple receives a score of 1/(4*6̂2), or 0.00347. In this way the data in the higher number ripples (farther from the origin) are progressively dampened, corresponding to a lower ranking, much like a physical ripple in water or another medium diminishes in amplitude the further it travels from its origin.

The system and method could analyze how well sites credit the sources of their information by combining it with link analysis. For example, if an appearance in ripple 3 (repeater) or beyond does not show a link back to discovers and curators, its ranking is lowered.

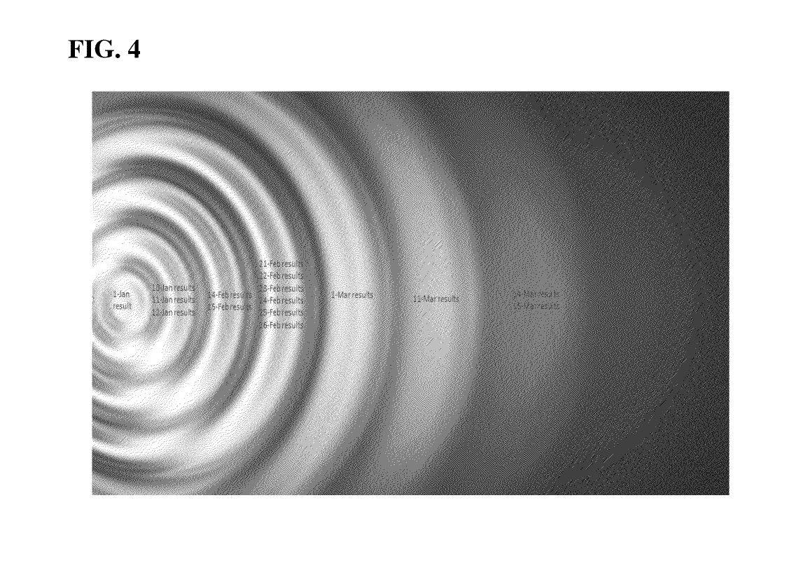

The system and method can be displayed to the user simply as a listing of results based on ripple score, as a listing of results based upon designation (creator, discoverer, etc.), or in combination with a graphical representation of a ripple (see FIG. 4). The graphical representation may be a literal representation of a ripple or an abstracted representation of a ripple or sections of a ripple. Results may be displayed in a variety of ways, for example as linked URLs, titles, short descriptions, images or video, as appropriate and common to the art.

While preferred embodiments of a search engine system and method employing wave equations for classifying and ranking search results have been described in detail, a person of ordinary skill in the art understands that certain changes can be made in the number and arrangement of the steps of the method as well as the type of components used in the system and method without departing from the scope of the following claims.

What is claimed:

1. A system for classifying and ranking internet search results, the system comprising:
computer means for detecting at least one of a peak and a trough in an internet search result;
computer means for sorting the internet search result according to at least one of the detected peak and detected trough in which the internet search result appears; and
computer means for displaying the sorted internet search result.

2. A system according to claim 1 wherein the detected peak and the detected trough are described using at least one wave equation.

3. A system according to claim 1 wherein the internet search result is categorized according to the detected peak or detected trough in which the internet search result appears.

4. A system according to claim 1 wherein the internet search result is assigned a score as a function of the detected peak in which the internet search result appears and a number of other internet search results in the detected peak.

5. A system according to claim 1 further comprising the displayed internet search result being in the form of a ripple.

6. A system according to claim 5 wherein the internet search result has a score that is inversely proportional to a number of the ripple and a number of internet search results in the ripple.

7. A method for classifying and ranking internet search results, the method comprising the steps of:
detecting at least one of a peak and a trough in an internet search result using a computer means;
using the computer means to sort the internet search result according to the detected peak or detected trough in which the internet search result appears; and
displaying the sorted internet search result.

8. A method according to claim 7 further comprising the step of using at least one wave equation to describe the detected peak and the detected trough.

9. A method according to claim 7 further comprising the step of categorizing the internet search result according to the detected peak or detected trough in which the internet search result appears.

10. A method according to claim 7 further comprising the step of assigning a score to the internet search result as a function of the detected peak in which the internet search result appears and a number of other internet search results in the detected peak.

11. A method according to claim 7 further comprising the step of displaying the internet search result in the form of a ripple.

12. A method according to claim 11 further comprising the step of assigning a score to the internet search result that is inversely proportional to a number of the ripple and a number of internet search results in the ripple.
